(19) United States
(12) Patent Application Publication
(10) Pub. No.: US 2003/0180071 A1
(43) Pub. Date: Sep. 25, 2003

(54) Image formation apparatus

(76) Inventor: Takeo Suda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/362,078

(22) PCT Filed: Nov. 2, 2001
(86) PCT No.: PCT/JP01/09613

(30) Foreign Application Priority Data
Nov. 2, 2000 (JP) 2000-335671

(51) Int. Cl. G03G 15/00; G03G 15/02

(52) U.S. Cl. 399/159; 399/176

(57) ABSTRACT

An image formation apparatus having a charge unit that charges a photosensitive member without contact, capable of accurately maintaining the gap between the charge member and the photosensitive member is provided. A gap keeping member is formed on the both ends outside the image area of a charge roller (1) as the charge unit by coating a diamond-like carbon film (3). The charge roller can be rotated, accompanied by rotation of the photosensitive member (6) via the diamond-like carbon film (3) contacted with the rotation of the photosensitive member (6). Thereby, the uniform charge can be applied by accurately maintaining the gap G with respect to the photosensitive member (6). The gap between the charge roller (1) and the photosensitive member (6) formed by the diamond-like carbon film (3) at the time is 100 μm or less, and both the direct current voltage and the alternative current voltage are superimposed between the charge roller (1) and the photosensitive member (6).

### TECHNICAL FIELD

The present invention relates to an image formation apparatus, such as a copying machine, a printer and a facsimile, that employs electro-photography. More specifically, the present invention relates to an image formation apparatus having a charge unit that applies charge to a photosensitive member without making a contact with the photosensitive member.

### BACKGROUND ART

In case of electro-photography, an electric charge is applied to a photosensitive member with a charge unit and, an electrostatic latent image is formed selectively erasing or reducing the electric charge by exposure. The charge units that employ the corona discharge and do not make a contact (non-contact charge unit) with the photosensitive member have been the mainstream. However, these non-contact charge units have disadvantage that they generate a large amount of ozone. Moreover, since the corona discharge requires a high voltage of 5 kV to 10 kV, a high voltage generator is required whereby the cost reduction was not possible.

Recently, charge units that make a contact (contact charge unit) with the photosensitive member and do not employ the corona discharge have been proposed. Such contact charge units may apply voltage in two ways. First, apply only a direct current voltage (DC). Second, apply a direct current voltage with an alternative current voltage (AC) superimposed on it.

Although the contact charge unit does not have the problems that were there in the non-contact charge unit, it has a problem that the electric charge applied to the photosensitive member is uneven. If the electric charge is uneven then a desired visual image is not formed. Precisely, if the electric change is uneven the charge potential generated on the photosensitive member is uneven and the image density is not as desired. As a result, some of the portions of the image may be lost and thereby degrade the image quality.

Moreover, in case of the contact charge unit, there is a possibility that foreign particles get trapped between a member that is charged and the photosensitive member. In that case, the charge member may not generate the desired electric charge. Also, the photosensitive member may be polluted or pushed due to the direct contact with the charge member in process of long term use. In that case, a visual image having lateral stripes may be generated.

To solve these problems, a configuration in which the charge member and the photosensitive member do not contact each other has been proposed.

For example, an image formation apparatus has been disclosed in the Japanese Patent Application Laid-Open No. 7-301973. This apparatus has a charge device with a roller. An electric charge is applied onto the roller and, the roller is rotated. The roller is provided such that there is a gap of 30 μm to 240 μm between it and the photosensitive member. According to this prior art image formation apparatus, it is possible to prolong the life of the life of the photosensitive member and also generate less ozone. However, there is a problem with this prior art in that it is difficult to ensure and maintain the gap between the roller and the photosensitive member.

Moreover, a charge device has been disclosed in the Japanese Utility Model Application Laid-Open No. 5-15057. In this charge device, a ring-like elastic spacer is mounted on an end of the photosensitive member so that the charge roller does not make a contact with the photosensitive member. However, in this prior art charge device, since the spacer is made of elastic material it get distorted in the long term use and again there is a problem that the gap between the roller and the photosensitive member is difficult to ensure and maintain.

It is an object of the present invention to provide an image formation apparatus capable of maintaining the gap between the charge member and the photosensitive member accurately.

### DISCLOSURE OF THE INVENTION

The present invention provides an image formation apparatus comprising, a photosensitive member that forms an electrostatic latent image by exposure, a charge unit with a charge member that charges the photosensitive member without contact disposed, and a gap keeping member that keeps the charge unit and the photosensitive member without contact, wherein the gap keeping member is a diamond-like carbon film formed by coating at the end of the charge member, which is contacted with the photosensitive member.

The next invention is the image formation apparatus according to claim 1, wherein the charge member has a cylindrical shape so as to be rotated, accompanied by rotation of the photosensitive member.

The next invention is the image formation apparatus according to claim 1, wherein the charge member has a shape so as to be contacted with the photosensitive member via the gap keeping member by an arc, without rotation of the charge member.

The next invention is an image formation apparatus comprising a photosensitive member that forms an electrostatic latent image by exposure, a charge unit with a charge member that charges the photosensitive member without contact disposed, and a gap keeping member that keeps the charge unit and the photosensitive member without contact, wherein the gap keeping member is a diamond-like carbon film formed by coating at the end of the photosensitive member, which is contacted with the photosensitive member.

The next invention is the image formation apparatus according to any one of claims 1 to 4, wherein the gap between the charge unit and the photosensitive member formed by the diamond-like carbon film is 100 μm or less, and both the direct current voltage and the alternative current voltage are superimposed between the charge member and the photosensitive member.

### BRIEF DESCRIPTION OF THE DRAWINGS

FIG. 1 is a perspective view that shows an embodiment of a charge unit according to the present invention,

FIG. 2 is a cross-sectional view that shows another embodiment of a charge unit according to the present invention, and

FIG. 3 is a perspective view that shows another embodiment of a gap maintaining member according to the present invention.

### BEST MODE FOR CARRYING OUT THE INVENTION

Exemplary embodiments of the present invention will be explained in detail with reference to the accompanying drawings.

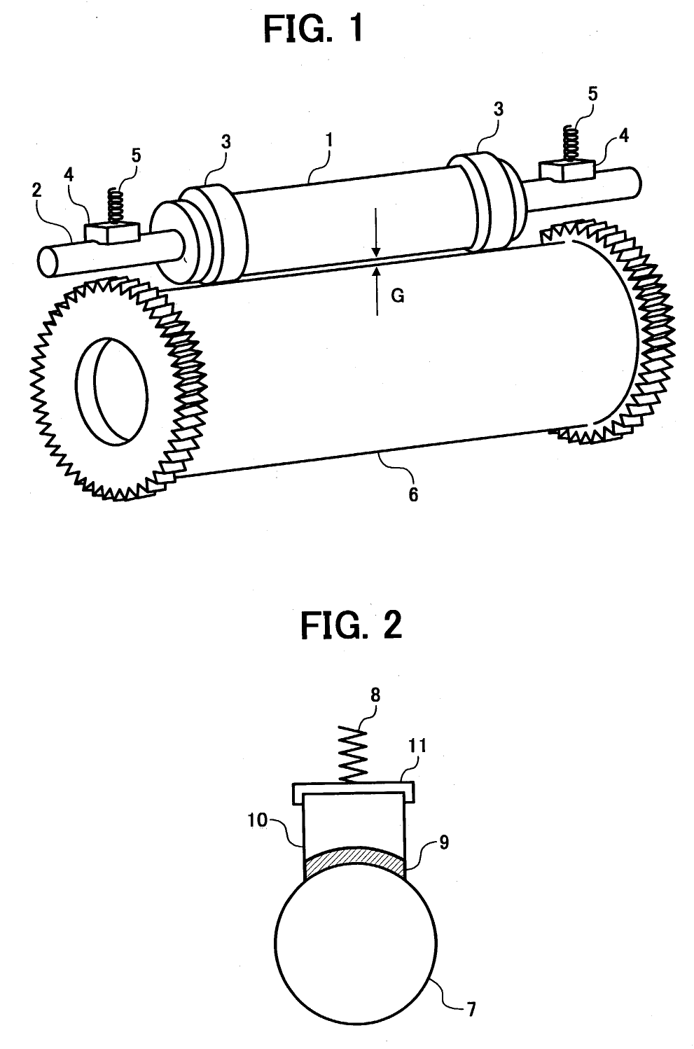

FIG. 1 is a perspective view of a charge unit according to an embodiment of the present invention. A charge roller 1 is pressured in the photosensitive member 6 direction by a pressuring spring 5 via a bearing 4 disposed at the shaft 2 end. A diamond-like carbon film 3 coated integrally on the charge roller 1 is provided at the end outside the image area of the charge roller 1 so as to form a gap G with respect to the photosensitive member 6.

The diamond-like carbon film 3 is an amorphous carbon film with high hardness. The diamond-like carbon film 3 may be formed with any of the following known process: ionization deposition, ion beam deposition, ion beam sputtering, ion plating, high frequency plasma method, and CO₂ laser induced discharge.

The obtained diamond-like carbon film 3 is an extremely hard film having 2,000 to 4,000 Vickers hardness. Therefore, although a problem is involved in that the gap G is changed due to deformation of the member by the forcing power of the pressuring spring 5 according to a material such as a resin conventionally used for keeping the gap between the charge member and the photosensitive member, the gap G can be maintained extremely accurately by forming the gap keeping member as the diamond-like carbon film. Additionally, since the excellent wear resistance can be provided, it is endurable for the long term use.

Since the diamond-like carbon film 3 is amorphous without the grain boundary, the excellent surface smoothness can be provided with extremely small friction coefficient. Therefore, abrasion of the surface of the photosensitive member to be contacted can be restrained.

The charge roller 1 can be rotated, accompanied by rotation of the photosensitive member 6 via the diamond-like carbon film 3 in contact with the photosensitive member 6. Thereby, even charge can be obtained. To the photosensitive member 6 accordingly charged evenly, a laser beam is directed by a not shown exposing unit for forming an electrostatic latent image, and thereafter, the next step of the electro-photography process is executed.

In contrast, to prevent vibration of the charge member, the charge member can be fixed. FIG. 2 is a cross-sectional view that shows another embodiment of the charge unit according to the present invention. A charge member 10 held by a holder 11 having an arc-like shape in the surface facing the photosensitive member 7, is pressured in the photosensitive member 7 direction by a pressuring spring 8. A diamond-like carbon film 9 for forming the gap between the charge member 10 and the photosensitive member 7 is coated on the both ends of the charge member 10. Since the diamond-like carbon film 9 has the extremely preferable wear resistance and sliding property, the gap G can be maintained extremely accurately without changing the gap G by sliding against the photosensitive member in the long term use even though the unrotated charge member 10 is used.

To the shaft 2 shown in FIG. 1, a direct current voltage (DC) and an alternative current voltage (AC) are superimposed and applied from a not shown power source. According to the DC application method, the ozone generation amount is small so that damage to the photosensitive member is little, the charge evenness can hardly be obtained. Therefore, the charge unit according to the present invention adopts an application method with the AC superimposed on the DC for obtaining further even charge.

The gap G between the photosensitive member and the charge member is provided by 100 μm or less. When the gap G is more than 100 μm, since the discharge amount for charging the photosensitive member to a predetermined potential is increased as well, film-like foreign substance adhesion is generated on the photosensitive member so as to provide an abnormal image. The gap G is adjusted by the film thickness of the diamond-like carbon film as the gap keeping member. To obtain a high hardness property in the diamond-like carbon film, the film thickness is preferably 1 μm or more, and therefore, the gap G between the photosensitive member and the charge member is preferably 1 μm or more and 100 μm or less.

Examples to be the ground of defining the gap G between the photosensitive member and the charge member will be shown below.

### EXAMPLE 1

Using a charge unit shown in FIG. 1, the film thickness of the diamond-like carbon film was adjusted so as to have the gap G between the photosensitive member and the charge member by 50 μm. The DC and the AC were superimposed and applied from the power source for charging the photosensitive member surface. The current needed at the time was measured. Moreover, the generation state of the film-like foreign substance on the photosensitive member after executing 12,000 sheets of image formation was examined.

### EXAMPLE 2

A test was conducted in the same manner as in the example 1 except that the gap G between the photosensitive member and the charge member was provided by 70 μm by adjusting the film thickness of the diamond-like carbon film.

### EXAMPLE 3

A test was conducted in the same manner as in the example 1 except that the gap G between the photosensitive member and the charge member was provided by 100 μm by adjusting the film thickness of the diamond-like carbon film.

### COMPARATIVE EXAMPLE 1

A test was conducted in the same manner as in the example 1 except that the gap G between the photosensitive member and the charge member was provided by 120 μm by adjusting the film thickness of the diamond-like carbon film.

Results of the examples 1 to 3 and the comparative example 1 are shown in the table 1.

TABLE 1

| | | | Film-like foreign |
|---|---|---|---|
| | | | substance adhesion |
| | | Needed | on the |
| | | application current | photosensitive |
| | | (alternative current | member after |
| | Gap G | component) | forming 12,000 |
| | (μm) | (mA) | sheets of images |
| Example 1 | 50 | 1.0 | Not generated |
| Example 2 | 70 | 1.2 | Not generated |
| Example 3 | 100 | 1.7 | Not generated |
| Comparative | 120 | 2.4 | Generated |
| Example 1 | | | |

It can be confirmed from the table 1 that the application current needed for charging the photosensitive member surface increases as the gap G becomes wider. According to the examination of the generation state of the film-like foreign substances on the photosensitive member after executing 12,000 sheets of image formation was examined, generation of the foreign substances was not observed in the examples 1 to 3, however, generation of the foreign substances was observed in the comparative example 1. The foreign substance adhesion on the photosensitive member is considered to be related to the discharge amount. As it is learned from the fact that the needed application current value is increased in the comparative example 1, it is considered to be caused by the discharge amount increase.

From the results mentioned above, it is preferable to set the gap G between the photosensitive member and the charge member at 100 μm or less, more preferably 70 μm or less.

As heretofore explained, according to the image formation apparatus of the present invention, since the gap with respect to the photosensitive member is formed by the diamond-like carbon film formed integrally on the charge member both ends by coating so that the gap can be maintained accurately without changing the gap by the pressuring force of the charge member in the photosensitive member direction, charging without irregularity can be enabled.

Since the diamond-like carbon film has the excellent wear resistance and sliding property, the gap between the charge member and the photosensitive member can be maintained accurately. Furthermore, since the gap between the charge member and the photosensitive member is provided by 100 μm or less, the alternative current value applied to the charge member can be reduces so that an abnormal image due to adhesion of the film-like foreign substance generated on the photosensitive member can be prevented.

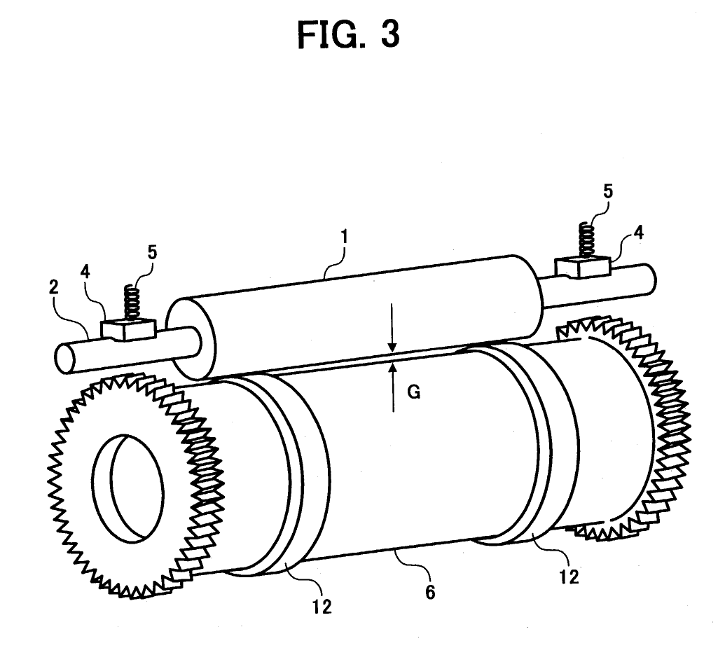

FIG. 3 is a perspective view that shows another embodiment of a gap keeping member according to the present invention. Although the diamond-like carbon film as the gap keeping member was provide on the charge unit side in the embodiments shown in FIGS. 1 and 2, here, a diamond-like carbon film 12 is formed as the gap keeping member by coating on the end of the photosensitive member 6 so as to contact the diamond-like carbon film 12 with the charge roller 1. According to the configuration, the gap between the charge roller 1 and the photosensitive member 6 can be maintained accurately so that charge without irregularity can be enabled, and thus the same effect as that of the embodiment can be provided. Although detailed explanation is omitted, it is preferable to have the gap between the charge member and the photosensitive member by 100 μm or less.

### INDUSTRIAL APPLICABILITY

As mentioned above, an image formation apparatus according to the present invention is suited for use in a copying machine, a printer, and a facsimile device for charging the photosensitive member without contact, in particular, in a high grade machine (an apparatus required to provide a high image quality) required to charge the photosensitive member uniformly.

1. An image formation apparatus comprising:
a photosensitive member that forms an electrostatic latent image by exposure;
a charge unit with a charge member that charges the photosensitive member without making a physical contact with the photosensitive member; and
a gap keeping member that maintains a gap between the charge unit and the photosensitive member,
wherein the gap keeping member is a diamond-like carbon film formed by coating at an end of the charge member, and the gap keeping member makes a physical contact with the photosensitive member.

2. The image formation apparatus according to claim 1, wherein the charge member has a cylindrical shape so as to be rotated, accompanied by rotation of the photosensitive member.

3. The image formation apparatus according to claim 1, wherein the charge member has a shape so the charge member makes a physical contact with the photosensitive member via the gap keeping member by an arc, without rotation of the charge member.

4. An image formation apparatus comprising:
a photosensitive member that forms an electrostatic latent image by exposure;
a charge unit with a charge member that charges the photosensitive member without making a physical contact with the photosensitive member; and
a gap keeping member that maintains a gap between the charge unit and the photosensitive member,
wherein the gap keeping member is a diamond-like carbon film formed by coating at an end of the photosensitive member, and the gap keeping member makes a physical contact with the charge member.

5. The image formation apparatus according to any one of claims 1 to 4, wherein the gap between the charge unit and the photosensitive member formed by the diamond-like carbon film is 100 μm or less, and both the direct current voltage and the alternative current voltage are superimposed between the charge member and the photosensitive member.
